(19) United States
(12) Patent Application Publication
(10) Pub. No.: US 2009/0292586 A1
(43) Pub. Date: Nov. 26, 2009

(54) Strategic Visioning System Using Bisociation Brainstorming

(76) Inventor: Howard S. Rasheed, Wilmington, NC (US)

Correspondence Address: COATS & BENNETT, PLLC, 1400 Crescent Green, Suite 300, Cary, NC, 27518, US

(21) Appl. No.: 12/410,227

(22) Filed: Mar. 24, 2009

Related U.S. Application Data
(63) Continuation of application No. 10/998,341, filed on Nov. 27, 2004, now abandoned.

(51) Int. Cl. G06Q 10/00; G06T 11/20

(52) U.S. Cl. 705/10; 345/440

(57) ABSTRACT

The instant invention is directed to a novel approach to identification and evaluation of the trends affecting a particular organization. By use of a specially designed software package, the participants in the evaluation are able to analyze and codify opportunities and/or threats that are present in the environment of the organization and to brainstorm solution as result of the codification of the stresses confronting the organization. This is accomplished by use of the software in a unique bisociational approach.

### CROSS REFERENCE TO RELATED APPLICATION

This application is a continuation of U.S. patent application 10/998,341, filed on Nov. 27, 2004, and herein incorporated by reference in its entirety.

### BACKGROUND OF THE INVENTION

In the business environment of today's corporate world, it has become increasingly important that institutions and their employees from executives on down generate new ideas and respond to changes in their business in order to meet new demands caused by the changes that the world in this fast paced society experiences. This requires in many instances long, tiresome meetings, which can end up with a lack of focus due to the nature of both the length and the complexity of the material presented and discussed. In addition, these meetings can end up with a lack of productivity due to the drifting of the participants caused by the shifting of the focus in the material as ideas evolve. Thus, the effectiveness of these meetings is diminished over time due to the lack of central focus and an inability to codify the information discussed in the meeting to prevent sidetracking of the participants.

In the past, many systems have been derived to initiate the development of material in these brain-storming meetings. Some of these range from exercises and game formats to encounter sessions, and have used games or even physical challenges to develop material. One such system is described in U.S. Pat. No 5,762,503 to Hoo et al. Here, an obstacle course is used incite the participants into creative thinking along with team building to overcome the obstacles.

Another team building, project oriented patent, U.S. Pat. 6,626,677 to Morse et al describes the use of an art project to enhance creative thinking, innovation, communication and teamwork.

A further patent to Torres et al, U.S. Pat. No. 6,079,984, teaches the use of various props and construction devices to construct an environment for problem solving. This patent is concerned again with team building, trust, problem-solving and leadership skills.

All the existing work is more concerned with the aspect of reacting to needs that have been identified as in some state of lacking in an organization and not in identification of new strategies for innovative approaches to changes in the organization or in the organization's environment. Thus, it has become apparent that a need exists for a method of plotting a course of new directions based on identification of innovations based on the perceived changes in the environment that an industry finds itself in. This approach is thus pro-active instead of re-active as the other seminar approaches have been in the past.

### BRIEF SUMMARY OF THE INVENTION

It is therefore an object of the invention to provide a system for identification of new trends.

It is a further object of the invention to provide a system for identification of opportunities and/or threats to an industrial entity.

It is yet another object of the invention to provide a method for dealing with ideas, solutions and strategies related to the new trends that become identified.

It is another object of the invention to provide an evaluation and implementation phase to develop the material identified by the new trend or threat phase.

It is a further object of the invention to provide a system for the facilitation of further codification of material after the conclusion of initial sessions to facilitate the on-going usefulness of the derived material.

It is an object of the invention to provide an internet or otherwise available program of software that facilitates the codification and organization of the useful information and permits further study to continue in an on-going fashion.

### BRIEF DESCRIPTION OF THE DRAWINGS

FIG. 1 is a depiction of the progression of the development of ideas that can be defined as historical in nature or futuristic.

FIG. 2 shows the relationship of the primary and secondary phases in the Strategic Visioning Model.

FIG. 3 is an expanded view of the interrelationship of the phases of Strategic Visioning Model.

FIG. 4 is a depiction of the interrelationship of the various aspects of the trend identification process used in the SVS process.

FIG. 5 is a further continuation of the introduction process, which is a log-in screen and registration form.

FIG. 6 shows the Welcome screen of the software program.

FIG. 7 shows the Incubator Idea screen of the software program.

FIG. 8 is an expanded Incubator Idea screen with an idea ready for transfer to the trends menu.

FIG. 9 is the List Trends screen.

FIG. 10 is an additional List Trends screen.

FIG. 11 shows the results of making a query in the List Trends screen.

FIG. 12 is an example of a trend classification screen.

FIG. 13 shows the results of the trend classification having been accomplished on the software screen.

FIG. 14 is an initial Trend Map screen.

FIG. 15 is a trend mapping report.

FIG. 16 shows the results of the selection of one the ovals on the map screen.

FIG. 17 shows a Trend Map Summary entry screen.

FIG. 18 shows a Trend Map plot.

FIG. 19 shows the first step in the bisociation process as applied to the trends categories.

FIG. 20 depicts the list of trends generated from clicking on the material in FIG. 19.

FIG. 21 shows the results of the choices made in the screen of FIG. 20.

FIG. 22 is the opportunities screen generated by a response to FIG. 21.

FIG. 23 is the List Opportunities screen.

FIG. 24 shows the manipulation of the opportunities with respect to classifications and uploads.

FIG. 25 shows the Upload Opportunity screen.

FIG. 26 is a representation of how a new idea is generated by bisociation from the upload opportunity screen.

FIG. 27 is the resultant idea generated from the bisociation of FIG. 26.

FIG. 28 is the screen showing the saved idea of FIG. 27.

FIG. 29 shows the screen used to make changes to an existing idea.

FIG. 30 is the idea appended screen.

FIG. 31 is the editing or deleting of ideas screen.

FIG. 32 shows the first Evaluate Trends screen.

FIG. 33 is the result of an evaluate trends selection.

FIG. 34 is the next evaluate trend screen in the process.

FIG. 35 is the Trend Evaluated response screen.

### DETAILED DESCRIPTION OF THE INVENTION

The instant invention is an approach to the stimulation of innovation and creativity in the private and public sectors of the economy. The approach is based on the premises that:
Community stakeholders and organizations must see strategic foresight to anticipate paradigm shifts in the societal environment and develop preferred alternative futures.
Innovation and creativity does not have to be serendipitous and left to the chance of random occurrences of inspiration.
Innovation and creativity can be institutionalized as a systemic and replicable process as part of the organization's strategic visioning.

One of the integral features of this system is the Strategic Visioning Conference. This is a format based on conferences used to define strategy in the past but not in the re-active sense, but in the pro-active sense.

What distinguishes the Strategic Visioning Conference is the use of a unique system for New Idea Creation and Management. It provides an organized, systematized, institutionalized and disciplined approach to clarify the “fuzzy front end” of idea creation.

Strategic Visioning conferences do not require participants to prepare papers or speeches in advance—all participants are held to be experts, and all participate equally. Visioning conferences are more productive when there is a broad cross-section of stakeholders to participate to ensure diversity.

The Strategic Visioning Conferences utilize a unique system to facilitate manipulation of brainpower and information. This tool is known as the Strategic Visioning System (SVS). This unique tool facilitates the creative brainpower of organizational and community stakeholders on addressing emerging issues and community problems to generate new and creative solutions to problems and opportunities for collaborative initiatives.

The SVS consists of three primary components:
Inputs
Process
Outputs
and two secondary components:
Evaluation
Implementation

The Input phase of the system consists of the traditional environmental scanning process. Specifically, environmental variables such as trends, driving forces, countervailing forces and paradigms are researched and introduced to the analysis.

The Process phase is the core of SVS that makes it unique and effective. It consists of a proprietary system for facilitating creativity based on the theory of bisociation. This interactive approach stimulates higher order brainstorming activities that can be systematized, institutionalized, and replicated.

The resulting Output from the discovery phase, as defined by the Input and Process phases, incorporates a higher order of brainstorming activity by analyzing the interactive effects of environmental factors to identify opportunities for, and threats to the organization or community. This system helps users produce more unexpected creations and novel discoveries.

The secondary stages of this process include Evaluation and Implementation. Evaluation of innovative ideas can be performed using tools such as Cost-Benefit Analyses or Feasibility Studies.

In the public and social sectors, Implementation can result in solving a problem and addressing emerging issues in the community. Organizations can, thus, proactively anticipate and adapt to dynamically shifting paradigms in the society.

### Conference Structure Overview

The most successful approach involves a two and half day investment of time in an undistracted environment. This amount of time may be varied as necessary or by analysis of the amount of material to be covered and this variation is considered with in the scope of ordinary skill in the art. This time frame enables participants, normally 30 to 60 in number, to more effectively develop a holistic approach to a situation than the traditional series of many fragmented meetings. Again the number of participants is considered a variant that is within the realm of ordinary skill in the art.

Preferably, participants engage in one or two activities prior to the Strategic Visioning exercises. One is an assessment of the participants' individual style of problem definition and solving. A second assessment involves determining the left-brain/right-brain tendencies of participants. If done prior to the sessions, this information can be used to condition and group participants for maximum diversity and productivity.

In the Input phase, participants are trained in the basic concepts of environmental scanning. To maximize effectiveness, participants are asked to research current periodicals for trends relevant to their industry, community or the society.

In the next stage, participants use the Strategic Visioning System to brainstorm opportunities and threats. Participants are introduced to the theory of bisociation of interactive affects.

The brainstorming process continues to the development of problem solutions, strategies, new policies, collaborations, and community action plans. Participants explore paradigm shifts, develop scenarios, make predictions, choose alternative futures, and project new visions for their environment.

Participants engage in group exercises that stimulate creative ideas. Initial activities use the workbook and hard copy approach for output to learn the principles of SVS. Participants are later introduced to /⁴/ SVS Software that will collect and share the massive amount of intellectual output from a productive session to maximize the interaction of collective group ideas.

The software is Internet-based to facilitate the continuation of the Strategic Visioning process when the conference concludes, establishing a culture of innovation among stakeholders and a never-ending pipeline of new ideas.

Each conference has projected or expected outcomes. Conference participants will learn a unique approach to developing and implementing a source of perpetual innovation in their organization. Potentially, new ideas generated at the session can stimulate entrepreneurial opportunities by participants; increase intellectual property development; and lead to the generation of new patent licenses between government agencies and industry or within an industry itself. The simulation is expected to serve as a pilot for demonstrating the effectiveness of SVS and the Bisociation Brainstorming™ concept as a tool for facilitating the commercialization of technology that can stimulate global entrepreneurial growth.

It is also expected that results from this simulated brainstorming session will encourage further development of ideas and trends in the future.

### The Strategic Visioning System

In order to promote innovation, the instant inventor has developed a system referred to as the Strategic Visioning System (SVS), a distinctive process for New Idea Creation and Knowledge Management. This system is prepared and delivered using a customized package of proprietary software, manuals, system training, group facilitations and follow-up consultations.

The distinctive advantage if the SVS is a novel process called Bisociation Brainstorming, which provides an organized, institutionalized, and disciplined approach to clarify the “fuzzy front end” of idea creation. Unlike other computer-aided Group Decision Support Systems and Electronic Brainstorming Systems, the Internet-based SVS software not only collects and shares information, but it also stimulates new idea creation in a systematic way that provides an endless source of incremental or radical innovation.

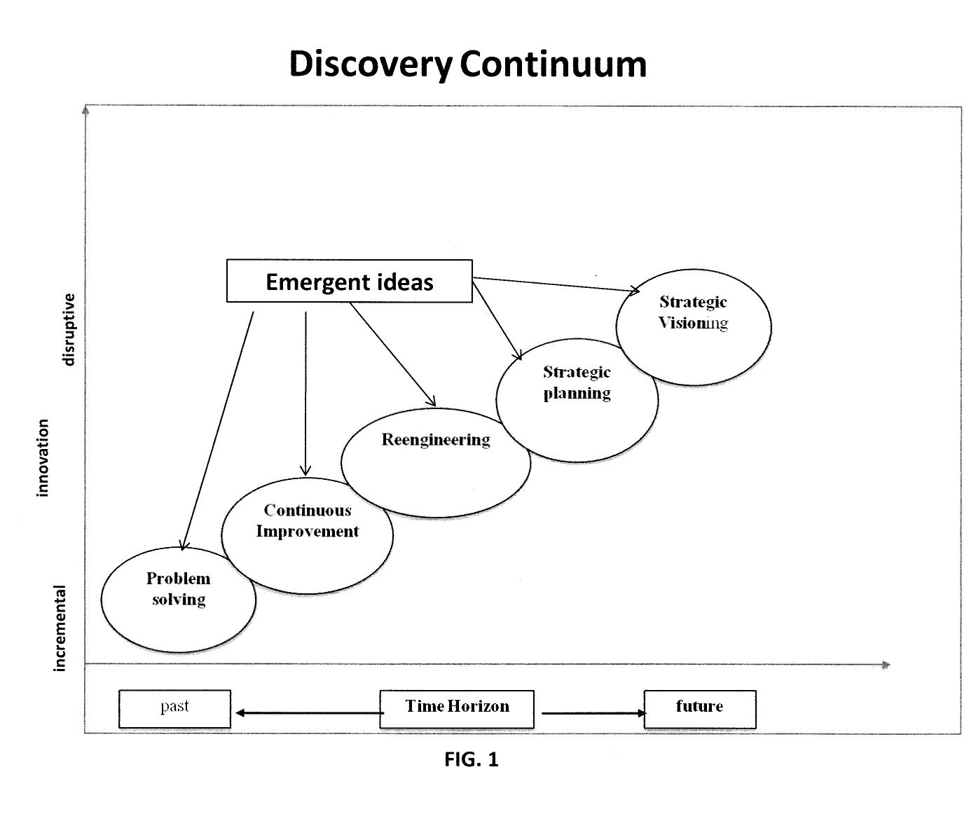

From this brainstorming process arises Emergent Ideas, which may manifest in a range of paradigm relatedness, based on whether the idea preserves the current paradigm or significantly modifies the existing paradigm. These emergent ideas also fall along a time horizon continuum that can range from problem solving (historical) to strategic visioning (futuristic). These emergent ideas can also apply to other popular organizational change models, such as continuous improvement, re-engineering, and strategic planning as indicated in FIG. 1.

The SVS consists of three primary phases: Inputs, Process and Outputs and two secondary phases: Evaluation and Implementation, as noted before.

The Input phase of the system consists of the traditional environmental scanning process. Specifically, environmental variables such as trends, driving forces, countervailing forces and paradigms are researched and introduced to the analysis.

The Process phase uses the novel Bisociation Brainstorming technique, which is the core of SVS, making it both unique and effective. This consists of a proprietary system for facilitating creativity based on the theory of bisociation. This robust interactive approach stimulated simultaneously multi-dimensional thinking activities that can be systematized, institutionalized and replicated. The Process phase incorporates a higher-order of brainstorming activity by analyzing the interactive effects of environmental factors to identify opportunities for, and threats to the organization or community.

Bisociation derives creative ideas from the intersection of two seemingly unrelated concepts by combining matrices of information. Bisociation refers to the pattern of perceiving of a situation or idea in two self-consistent but habitually incompatible frames of reference.

Bisociation is a type of analogical and metaphoric thinking process that leads to the acts of great creativity from the more familiar and mundane associative (purely logical) thinking. Bisociation is the mixture in one human mind of visual physiognomies from two contexts or categories of objects that are normally considered separate categories by the literal processes of the mind.

Bisociative thinking is distinct from associative thinking. Association refers to previously established connections among ideas while bisociation involves making entirely new connections among ideas.

This concept of bisociation is also distinct from the routine skills of thinking on a single plane and the creative act, which always operates on more than one plane. These planes are otherwise described as frames of reference, associative contexts, types of logic, codes of behavior, and universes of discourse.

The theory of bisociative thinking presumes that when two independent matrices of perception or reasoning interact with each other, the result is their fusion in a new intellectual synthesis, which can produce intellectually challenging effects. These matrices articulate any ability, habit, skill, or pattern of ordered behavior governed by a code of fixed rules. The more independent the matrices, the more unexpected and impressive the achievement, subsequently, the more novel the discovery.

In contrast to organizational learning, which is the acquisition of a new skill, bisociation is the combination, re-shuffling and re-structuring of skills. The term bisociation is meant to point to the independent, autonomous character of the matrices, which are brought into contact in the creative art, whereas associative thought operates among members of a single pre-existing matrix.

The resulting Output from this process helps organizations produce more unexpected creations and novel discoveries. Emergent ideas derived from these steps can therefore lead to new products, services, markets and strategies.

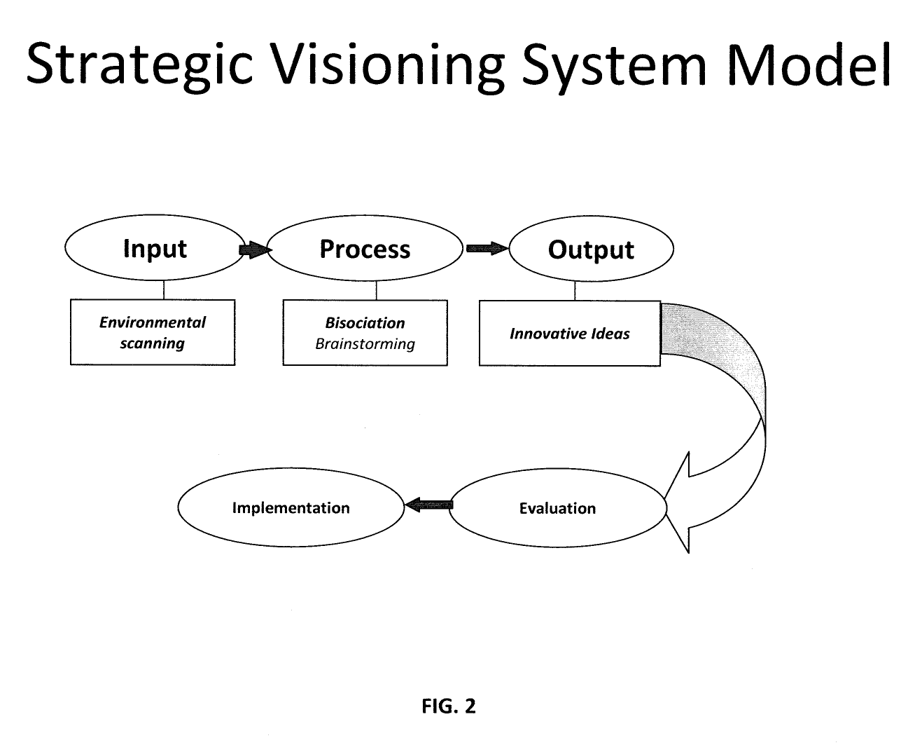

The relationship of the three primary phases is depicted in FIG. 2. The primary phases then lead to the secondary phases through evaluation of the material identified in the primary phases.

### The Strategic Visioning Model

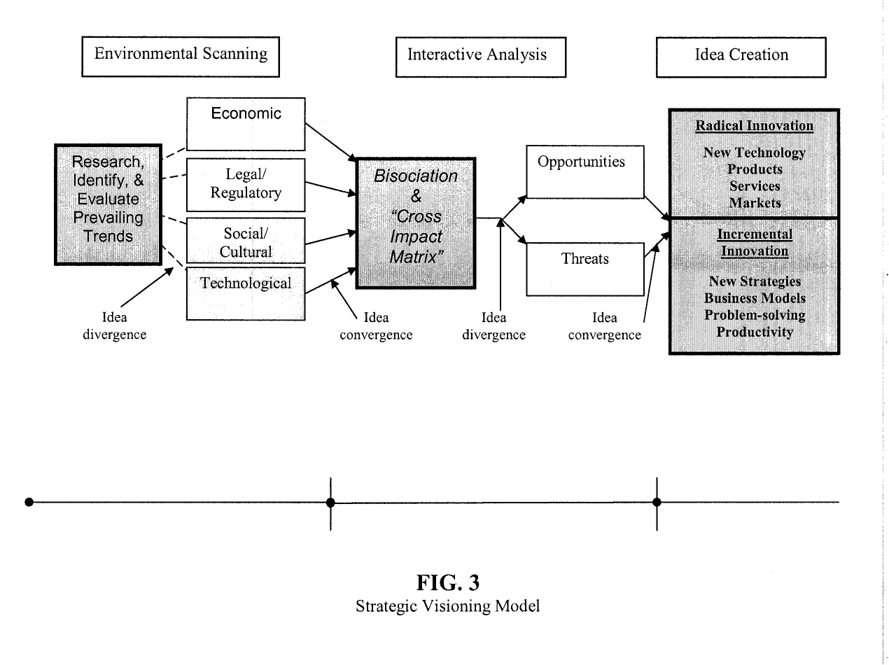

The Strategic Visioning Model is further defined below and is graphically depicted in FIG. 3 as a series of divergent and convergent creative procedures.
Environmental Scanning

The environmental scanning procedure involves researching and identifying prevailing trends from each of the four categories in a nominal (individual), anonymous, and asynchronous (independent) environment. In a group brainstorming session using a synchronous, gallery writing environment, with all group members simultaneously seeing the inputs, these prevailing trends are presented, discussed, and clustered/classified to eliminate irrelevance and duplication. Each participant votes on each major and/or minor classification of prevailing trends regarding the probability of occurrence and the relative impact on the industry, firm or other organization. A cumulative, weighted, or average score from all participating stakeholders voting on the inputs establishes a relative priority ranking.
Interactive Analysis: Bisociation of Trends using Cross Impact Matrices

In the brainstorming procedure, participants in the group focus on the highest-ranking trends and develop original ideas using the Bisociation Brainstorming technique, which focuses on the interaction of these prevailing trends taken two or more at a time. A Cross Impact Matrix graphically presents the outputs from this bisociation process as anticipated opportunities and threats or challenges are identified in the firm's or group's industrial environment. The resulting opportunities and threats are further prioritized based on the product scores of the interacting trends.
Emergent Idea Creation

The Cross Impact matrix output of opportunities and threats from the brainstorming session facilitate the generation of new ideas, solutions, and strategies. These innovations capitalize on new opportunities or minimize related threats and challenges. Innovations can be articulated as potential new markets, applications, processes, products, supply sources, services, strategies, problem solutions, organizational structures, distribution systems, public policy, or new combinations of transaction architecture and exchange mechanisms, such as electronic commerce. The ideas are evaluated based on their value potential, success feasibility, and paradigm relatedness.
Evaluation and Implementation—Secondary Phase

In the Evaluation phase, the organization's relevant internal factors, or strengths and weaknesses, are used to assess the feasibility of the innovation as part of the overall strategy formulation and implementation process. From this evaluation, feasible radical and incremental innovations and supportive infrastructure and systems, are endorsed. These are relevant to the organization's distinctive competences.

The Implementation phase of this brainstorming process can produce radical innovations of new value-added products or services that can be commercialized and new markets can be developed. Organizations can re-engineer their core competences and reinvent their business models. Incremental innovations of new processes, supply sources, and exchange mechanisms can result in new support infrastructure, new organizational structures and information systems, as well as the development of new knowledge resources. Novel ideas can then take the form of new strategies, strategic alliances, outsourcing arrangements, cost cutting and efficiency enhancing initiatives, problem solutions and corporate policy.

### Electronic Brainstorming System

The Strategic Visioning System uses an Internet-based system/software/tool that supports the Bisociation Brainstorming concept. This Group Decision Support System, or groupware tool, includes user database software at multiple organizational levels, a technical manual, training, group facilitation and report generation.

SVS processes are presented in an Internet-based software to support individual brainwriting and recording of new ideas; group brainstorming for converging on optimal ideas and evaluation of ideas; group interaction to clarify, illuminate, and advance the value of commercial applications of technology.

### System Benefits

The benefits derived from the use of the Strategic Visioning Software System are:
Creation of a replicable systemic approach to creativity and innovation;
Creation of a continuous source of value-added ideas;
Facilitates a culture of innovation;
Establishes a methodology for higher-order critical thinking and brainstorming
Fosters product creation and continuous process improvement;
Reduces cost of a continuous strategic planning and brainstorming process;
Extends involvement in new idea creation to all levels, geographic locations, and functions of the organization, including external stakeholders;
Provides a perpetual repository, dissemination, and evaluation tool for enhancing new ideas in the organization;
Improves participant critical thinking processes and group dynamics.

### Example of a Working Seminar

This is a typical example of a seminar organized via the system of the instant invention. This seminar includes the mechanics used for each part of the process.

### Pre-Seminar Preparation

The SVS training agenda encompasses intensive group interaction in an undistracted environment. Participants are asked to complete two activities prior to the Strategic Visioning Seminar. One is an assessment of the participants' individual style of problem definition and solving, using a pre-distributed questionnaire based on the Kirston Adaption-Innovation Inventory and theory. A second assessment involves determining the left-brain/right-brain tendencies of the participants. A third assessment tool that can also be used is the Myers Briggs Personality Inventory. Participants can complete these assessment tools on the Internet and the output is later provided at the seminar. These assessment tools are used to condition and group participants for maximum diversity and productivity.

In the Input phase, the participants are trained in the basic concepts of the Strategic Visioning System and Bisociation Brainstorming. To maximize effectiveness, participants are asked to research current periodicals for trends relevant to their industry, business, society or community prior to the seminar. To assist participants in identifying trends, a publication entitled, “Outlook 2000”, in The Futurist, vol. 33, no. 10, is recommended reading as a starting point and is provided at the seminar to facilitate additional ideas on trends.

### The Bisociation Brainstorming Process

### Trend Identification Phase

(a) Participants/groups are asked to record their trends on post-it cards (trend cards) and these are stuck on the wall in areas designated for specific environmental categories.

(b) Participants/groups record the source of the information and originators initials on the back of the trend cards.

(c) Participants/groups vote on each other's trends (high, medium, low) in terms of relevance to industry and probability of occurrence, by affixing color-coded dots to the trend card.

(d) At the conclusion of the trend identification and voting phase the facilitator tallies the votes, and lists the (X) most significant trends in each of the four environmental categories (the number of trends can be determined by the group or the facilitator).

(e) To stimulate competition, rewards or recognition can be acknowledged for individuals and groups with the most trends that are listed as significant.

### Opportunity/Threat Identification Phase

In this stage participants are introduced to the Strategic Visioning System and the theory of bisociation of interactive effects, to brainstorm opportunities and threats or challenges.

(a) Each group makes 3 copies of trend cards of each of the top (X) trends in each of the four categories.

(b) Each group develops 18 opportunities/threats (external factor card) for each pair of trends from distinct categories.

(c) These opportunities are placed in a matrix configuration based on their bisociation.

(d) Each individual will then vote on the top (X) opportunities/threats using color-coded dots (high, medium, and low potential).

(e) Rewards or recognition can be acknowledged for individuals and groups with the most opportunities/threats that are collectively recognized as significant.

(f) The sequence in the opportunity phase can be repeated for identification of challenges, either specifically related to opportunities identified or generally.

(g) Particular attention is given to ideas that are tagged to preceding ideas that add value.

### Ideas, Solutions, and Strategies Phase

Once opportunities and any corresponding threats/challenges have been identified, the brainstorming process continues to the development of new products, new services, new processes, problem solutions, or strategies. In the public sector, the output can consist of new policies, collaborations and/or community action plans. Participants can continue to explore paradigm shifts, develop scenarios, make predictions, choose alternative futures, and project new visions for their environment.

(a) Each participant records their new ideas on a post-it card (idea card) and affixes it on the wall next to the relevant opportunity or threat. Any explanation or references can be recorded on the back of the card, as well as the originators identification.

(b) Each participant will vote on other ideas and make addendums to the ideas if they feel it can be clarified or improved. Any addendums can be posted next to the original idea using a different colored post-it card.

(c) Particular attention will be given to ideas that are tagged to preceding ideas that add value.

Evaluation and Implementation Phase (Time for this Phase is Not Available for a Short Version of this Model

(a) The top (X) ideas are selected to develop scenarios in groups. Groups perform the “Headlines Exercise” to describe how idea will affect the future and shift paradigms.

(b) Participants explore forecasts and predictions relative to the priority ideas.

(c) At the conclusion of the group session, task forces or committees are assigned to evaluate the top (X) ideas using techniques such as cost benefit analysis, technology impact assessment, and feasibility analysis. These groups will meet after the training session as often as needed to develop and implementation plan or evaluate the proposed ideas.

(d) Reports will be presented to management, or at a follow-up session of the group, as determined by senior management.

### SVS Software Training Phase

After engaging in manually facilitated group exercises using the workbook and hard-copy output to learn the principles of SVS, participants are later introduced to the SVS Software. The software will facilitate the collection and sharing of the massive amount of intellectual output from a productive session to maximize the interaction of collective group ideas. As participants advance in their skills with Bisociation Brainstorming, they can progress to looking at the interaction of more than two variables at a time.

The software is Internet-based to facilitate the continuation of the Strategic Visioning System process when the conference concludes, establishing a culture of innovation among the stakeholders and a never-ending pipeline of new ideas.

### Key Features of the SVS Seminar

### General Characteristics

(a) Anonymity in brainwriting nominal phase and brainstorming group interaction
Negates stature or position of participants
Allows each comment to be evaluated on its own merit

(b) Reward allocation system
Identification tags
Proof of claim

(c) Decentralized
Multiple locations on system simultaneously
Greater participation
Enhanced anonymity

(d) Synchronous
Multiple users on system simultaneously

(e) Asynchronous
Multiple users on system independently

### Agenda

(a) Orientation

(b) Present situation, goal, problem on group computer screen

(c) Provide pre-printed post-it notes adhesive on two sides

(d) Brainwriting techniques

(e) Brainstorming techniques

(f) Encourage tagging or hitchhiking on preceding ideas

(g) Automatic classification, categorizing, clustering of ideas

(h) Ranking of ideas

### Industrial Sectors

(a) Health and Biotechnology

(b) Computer and Information technology

(c) Transportation

(d) Energy

(e) Ecology/environment

(f) Homeland security

### Methodology

The methodology of the seminar programs can be modified to satisfy specific need situations:

(a) Problem definition: structured or unstructured

(b) Assignment: closed or open-ended

(c) Theme: specific or undetermined

(d) Time limits: simulation overview (4 hours); orientation workshop (8 hours); corporate seminar (1.5-3 days)

(e) Climate: formal or informal

(f) Setting: work location or isolated neutral environment

(g) Pre-workshop assignment of trend research

(h) Complete assessment tools: adaptor/innovator and lateral thinking

(i) Choice of business sectors for seminar participants

(j) Reassignment to smaller groups to focus on particular ideas

(k) Documentation and reporting of seminar output

### General Seminar Logistics and Objectives

This is another set of variables that can be changed acceding to the particular seminar situation.

(a) Group size

(b) Group proximity

(c) Group structure and composition

(d) Time dispersion: asynchronous v. synchronous

(e) Time horizon: length of brainstorming activity

(f) Degree of anonymity

(g) Group session coordination: facilitator and/or recorder

(h) Task type

(i) Task complexity

(j) Intra-group assignments

### Procedures

Further variables available to customize the seminars, these may be implemented or left out.

(a) Give the participants one minute to gain concensus on the their preferred sector on a first come basis.

(b) Choices are displayed on their group terminal; choices appear as selected

(c) Post on board

(d) Classify and group

### Prioritization

(a) Use high, medium and low voting system

(b) Normalize rating to move to group average

(c) Do not rate your own ideas

(d) Input into computer

(e) Track output by innovator source

(f) Track output by lateral thinking score

### Research Measurement Metrics:

(a) Measure uniqueness idea based on the number of different trend combinations used

(b) Measure innovator score

(c) Measure lateral thinking score

(d) Measure paradigm relatedness

### Research Questions and Hypotheses:

The SVS seminar system contains many advantages:
Individuals with higher innovator scores will produce more ideas during the nominal phase of divergent brainwriting
Individuals with higher innovator scores will produce more unique ideas during the nominal phase of divergent brainwriting of trends
Individuals with higher innovator scores will produce opportunities from a greater variety of trend combinations
Individuals with higher innovator scores will produce less paradigm-related ideas during the nominal phase of divergent brainstorming
Individuals with lower innovator scores will produce more tagged/hitchhiked ideas during the nominal phase of divergent brainstorming
Groups with higher innovator scores will produce more ideas in the convergent brainstorming phase
Groups with higher innovator scores will produce more unique ideas in the convergent brainstorming phase
Groups with higher innovator scores will produce less paradigm-related ideas in the convergent brainstorming phase
Structured discussion question will produce less paradigm related ideas
Gallery writing techniques will produce more ideas
Participants in a reward system will produce more ideas

### SVS Software Package

The SVS seminar system also incorporates a software package that is customized to the implementation of the concepts and facilitating the flow of ideas and the codification of the material. This software is used primarily to facilitate the primary conference, but it is within the scope of the invention that this software may be modified to provide on-going support for further trend analysis as changes occur. Thus, with special access, the business concern may subscribe to an on-going service, which continues the process initiated in the initial seminar.

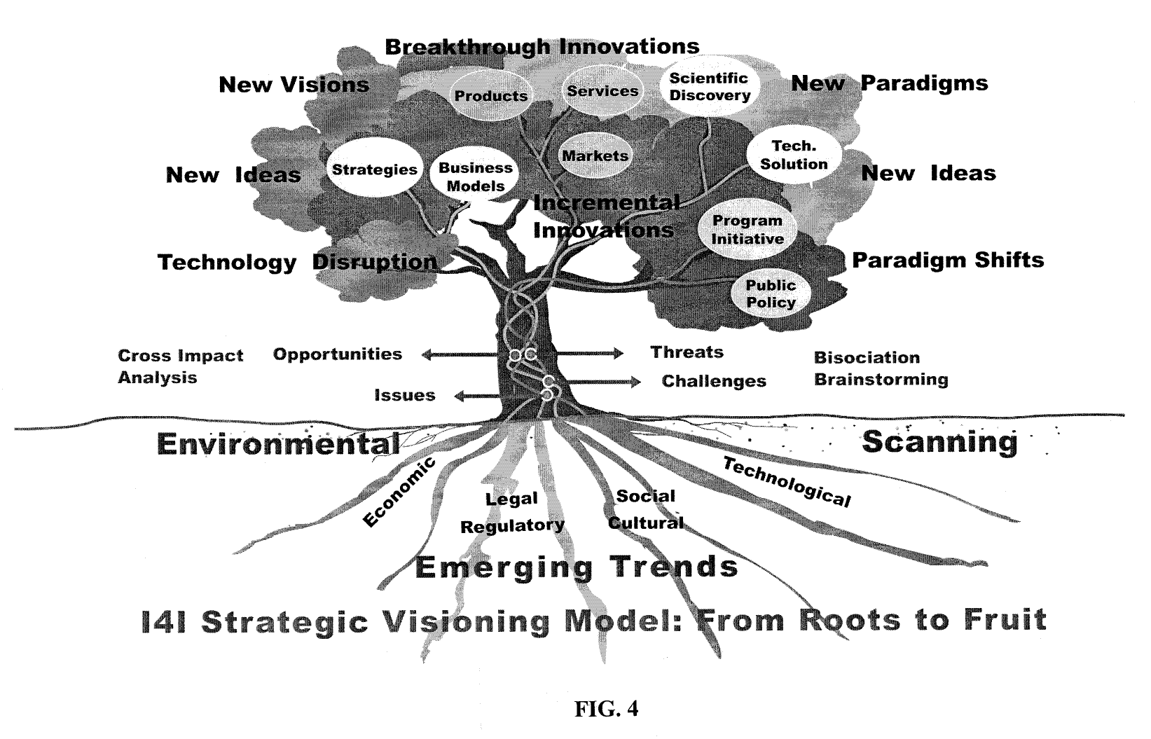

As shown in FIGS. 4-35, the software incorporates the basic principles of the SVS techniques and easily leads the participants through the SVS process. FIGS. 4-35 represent the actual screens and materials that the participant encounters in the SVS process.

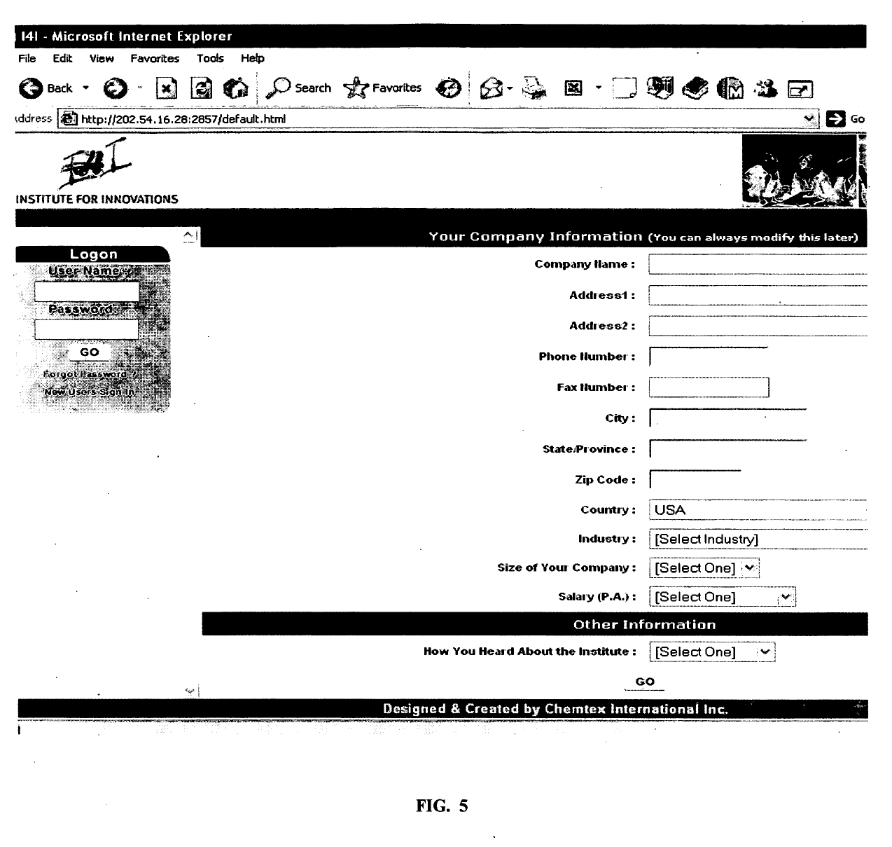

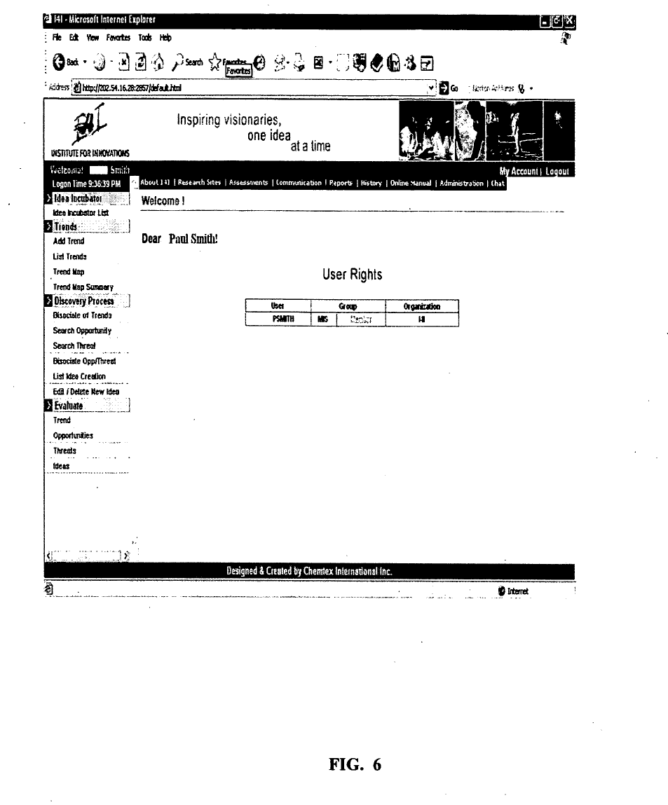

FIG. 4 is a depiction of the interrelationship of the various aspects of the trend identification process. Here the participant is confronted with the complex nature of the process and the interrelationship of the various facets of the codification process. FIG. 5 is a further continuation of the introduction process, which is a log-in screen and, additionally, a registration form. From there the participant proceeds to the Welcome screen, which is shown in FIG. 6. Here the first interaction with the software begins.

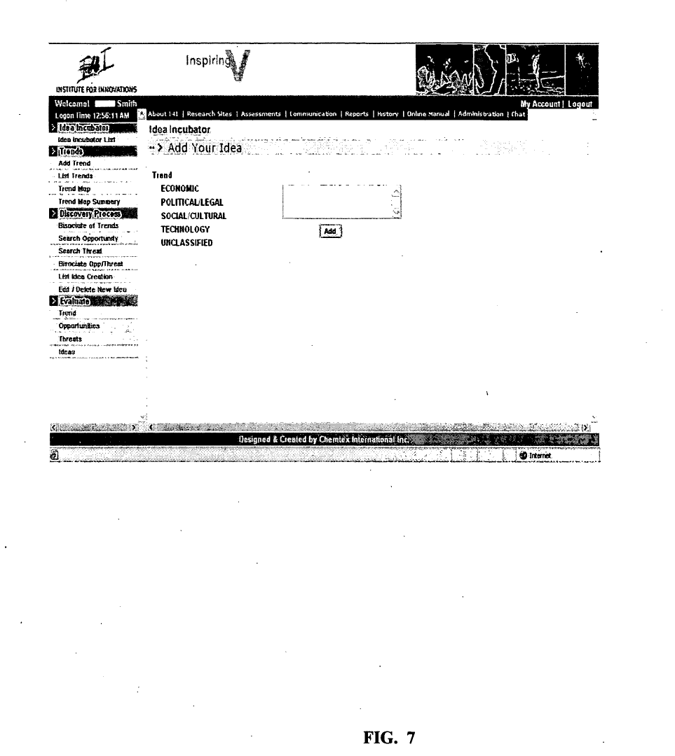

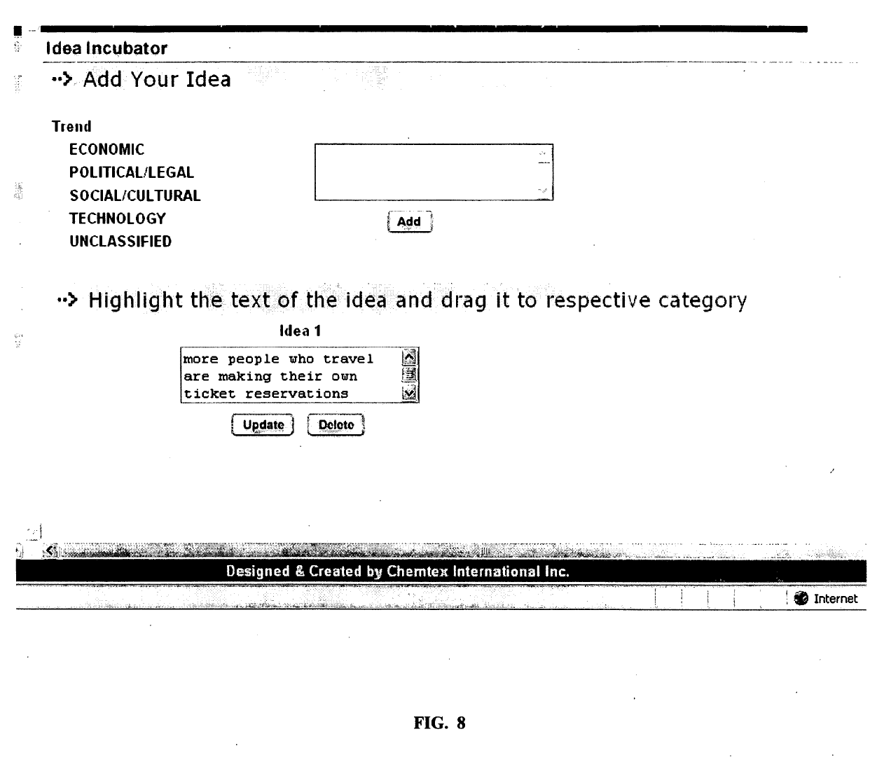

After the initial welcoming and registration process has occurred, the participant is then directed to the Idea Incubator Screen where the SVS process begins. This screen, shown in FIG. 7, is used for adding new ideas based on the pre-existing list of trends that are currently in the database as well as for the initial listing of trends as they are generated in the beginning of the process. In this screen, the participants also are able to link the idea to specific trends or types of trends. This portion of the process is shown in FIG. 8.

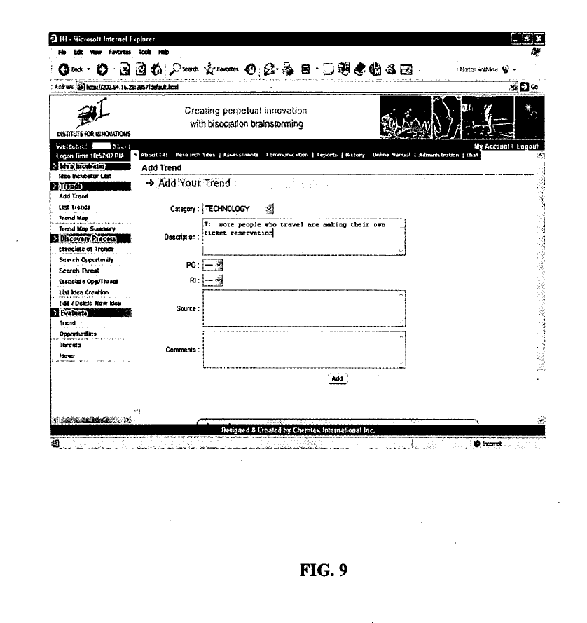

After the idea is physically dragged to the actual trend, the box shown in FIG. 9 will appear. This is the Add Trend box. Additionally, trends may also be added via the Add Trend Menu, but the follow-through from the Idea Incubator Screen gives continuity to the process of idea codification. Here the participants also identify the trends in terms of Trend, Predictions, Emerging Issues and What If Scenarios.

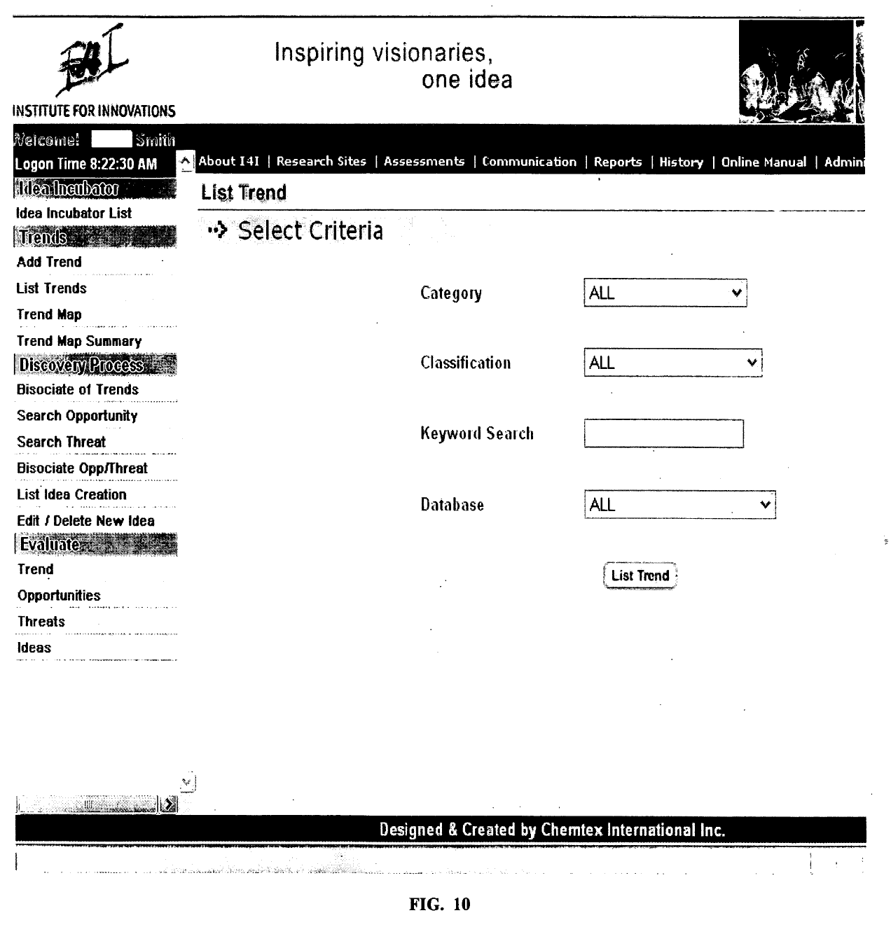

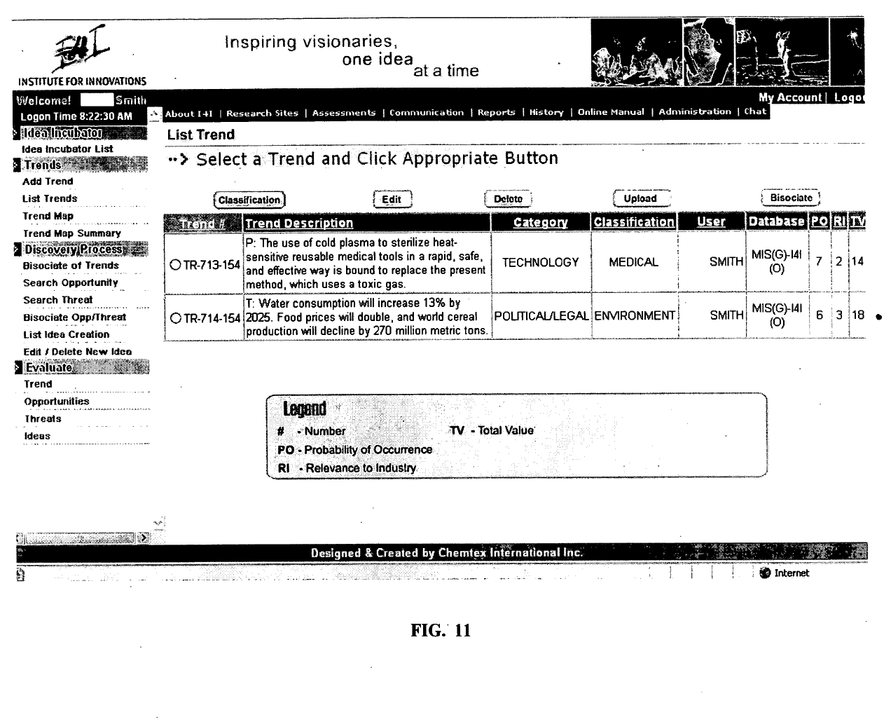

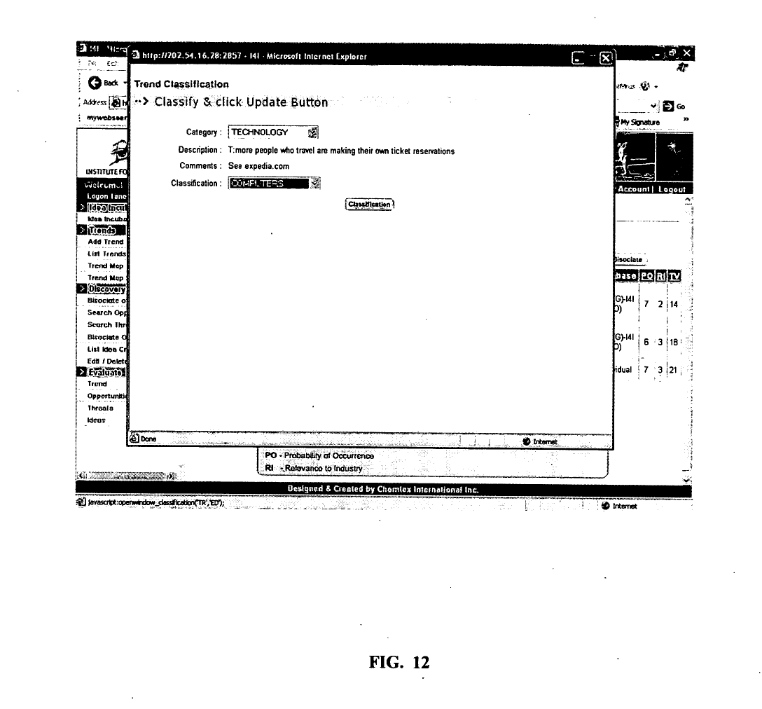

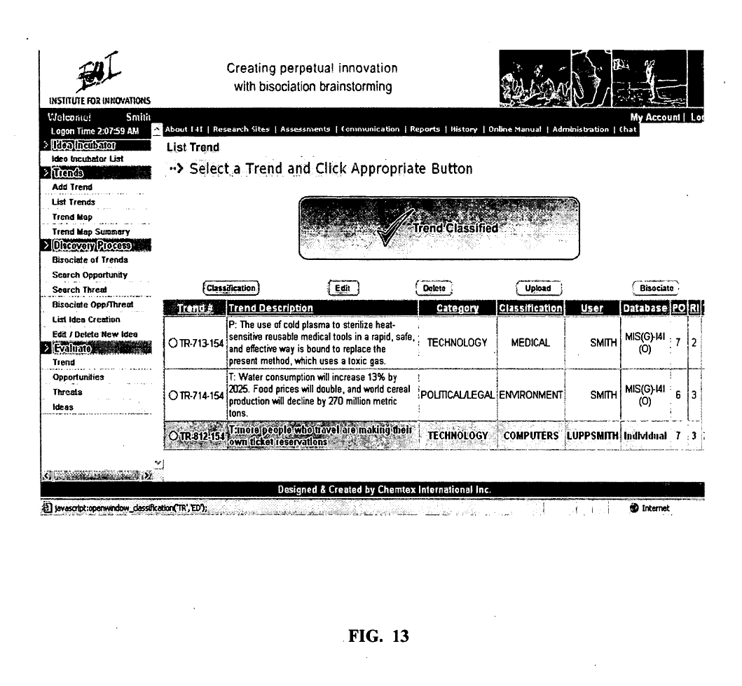

This Trend format screen is followed by another screen that lists all the trends identified and selections of specific categories may also be made. This screen is shown in FIG. 10. Here the participant can select category, classification, database or even do a keyword search. The results from making a query in this screen is shown in FIG. 11. The selected trend then can be classified by use of the classification screen as shown in FIG. 12. After the trend is classified, it reappears in the Trend screen as classified as shown by FIG. 13.

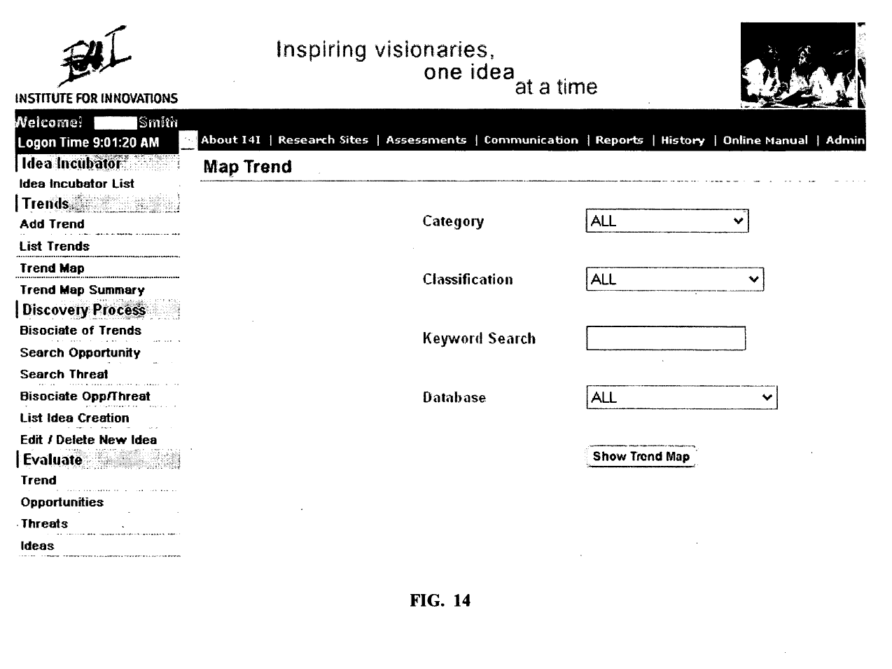

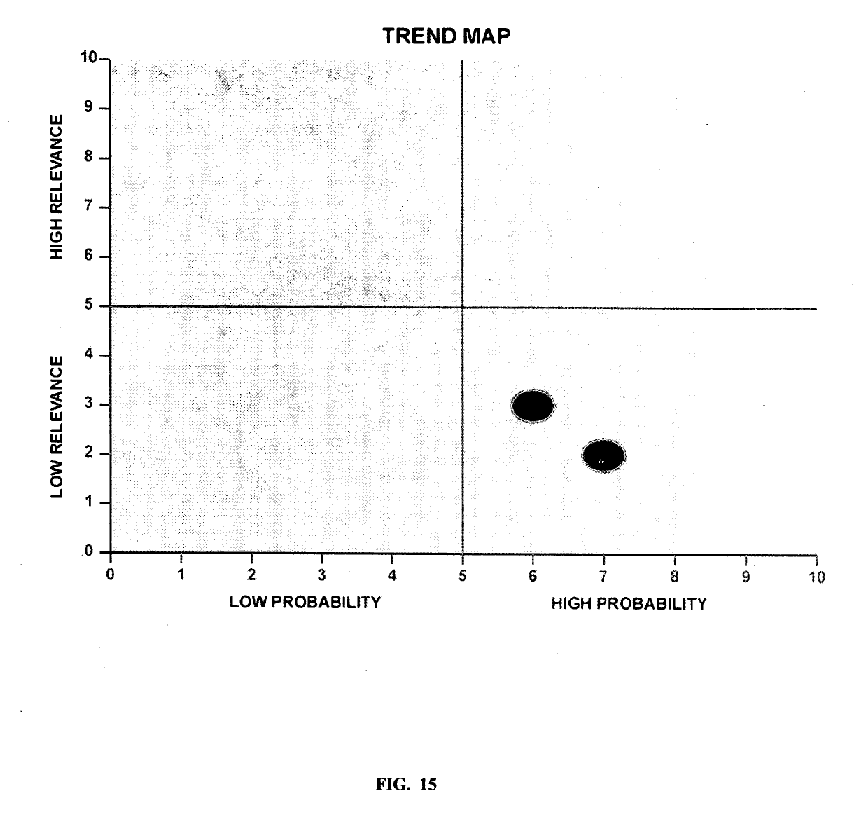

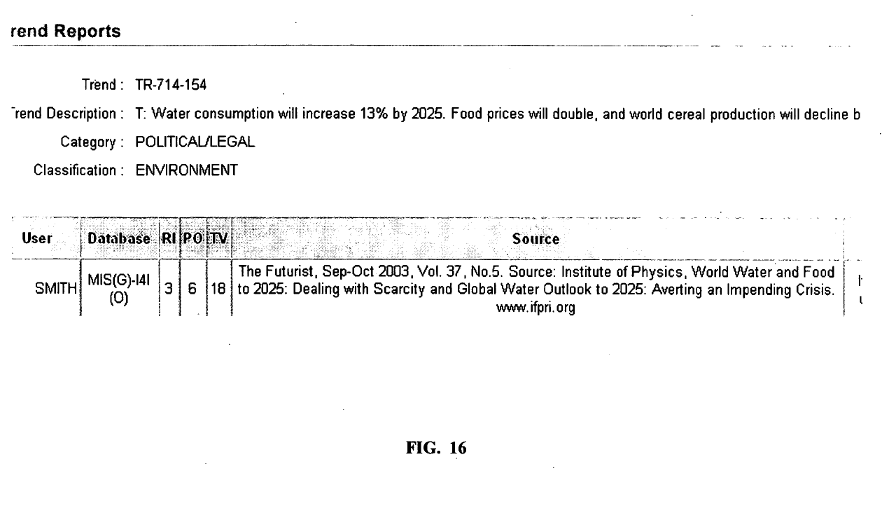

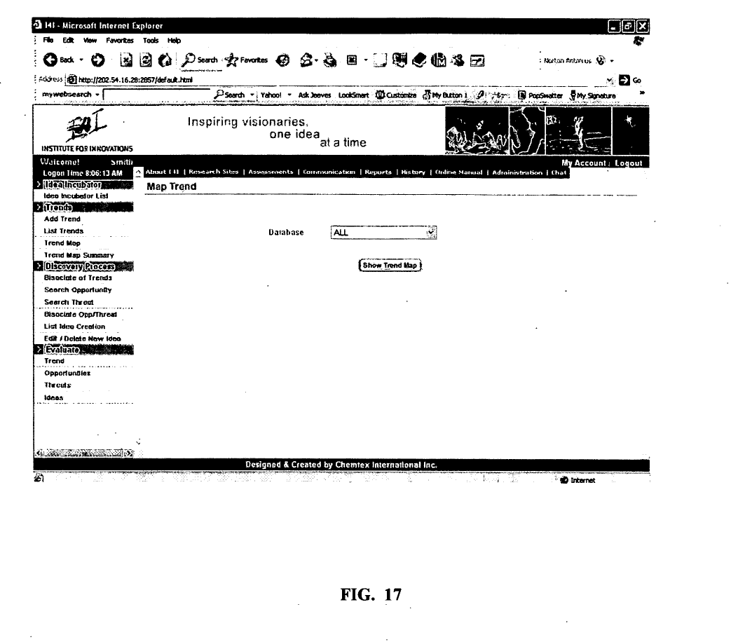

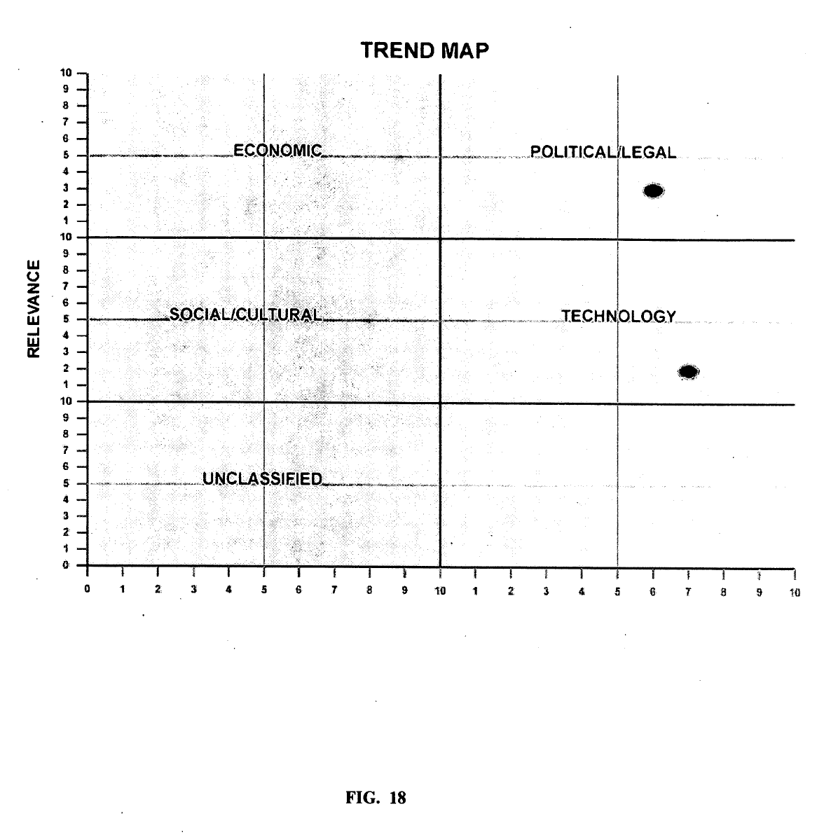

The next function of the software is to identify and codify the trends into a Trend Map as shown in FIG. 14. This map is depicted on a report as shown by FIG. 15. By clicking on any one of the ovals located on this screen, another screen appears, FIG. 16, that yields a trend report. Following this procedure, a Trend Map Summary is available. This is accessed through the screen shown in FIG. 17. A typical example of this summary is shown in FIG. 18.

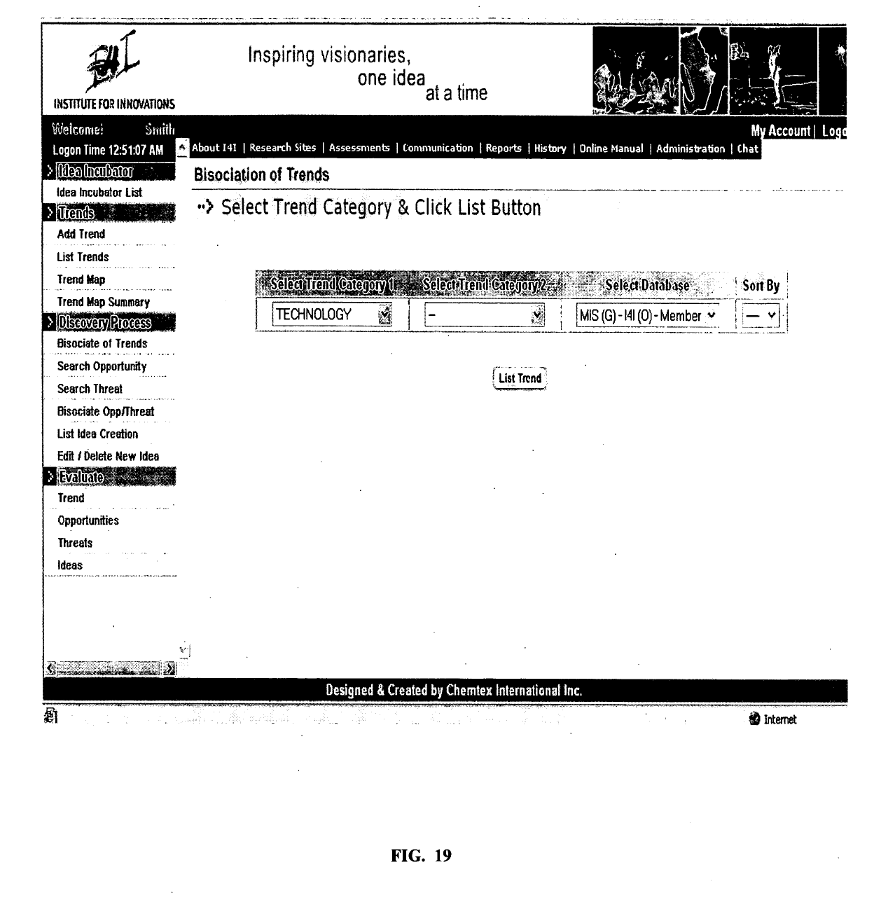

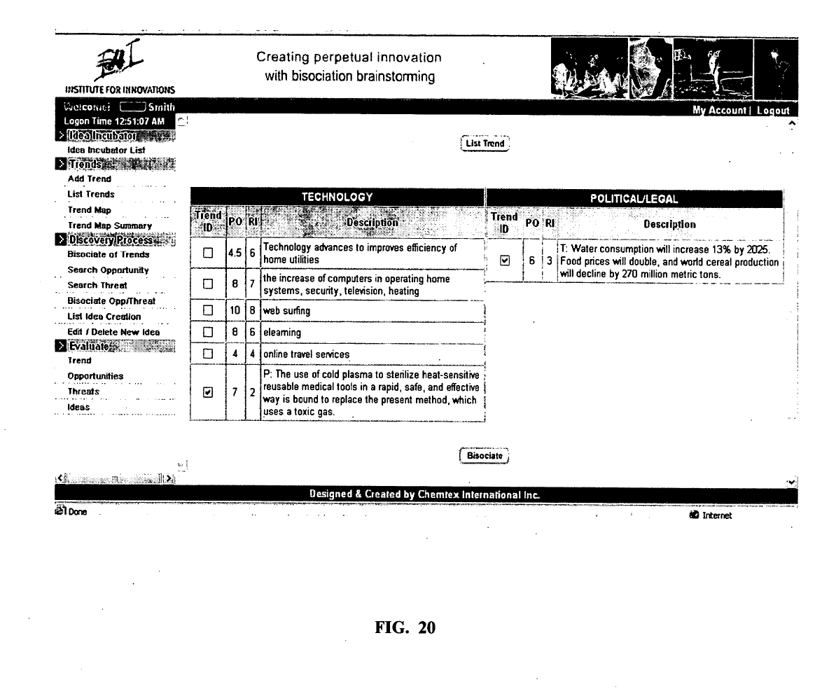

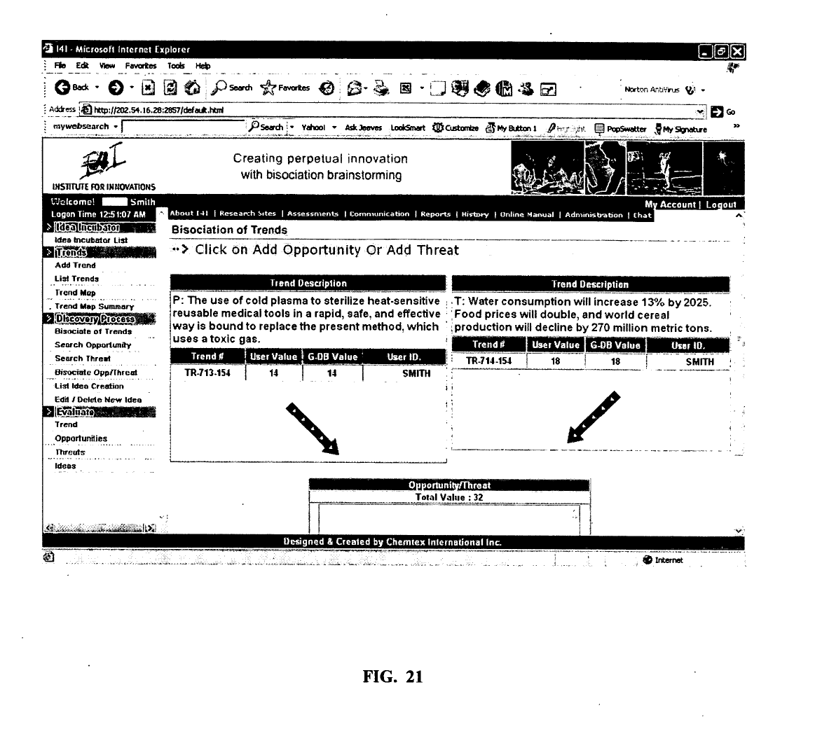

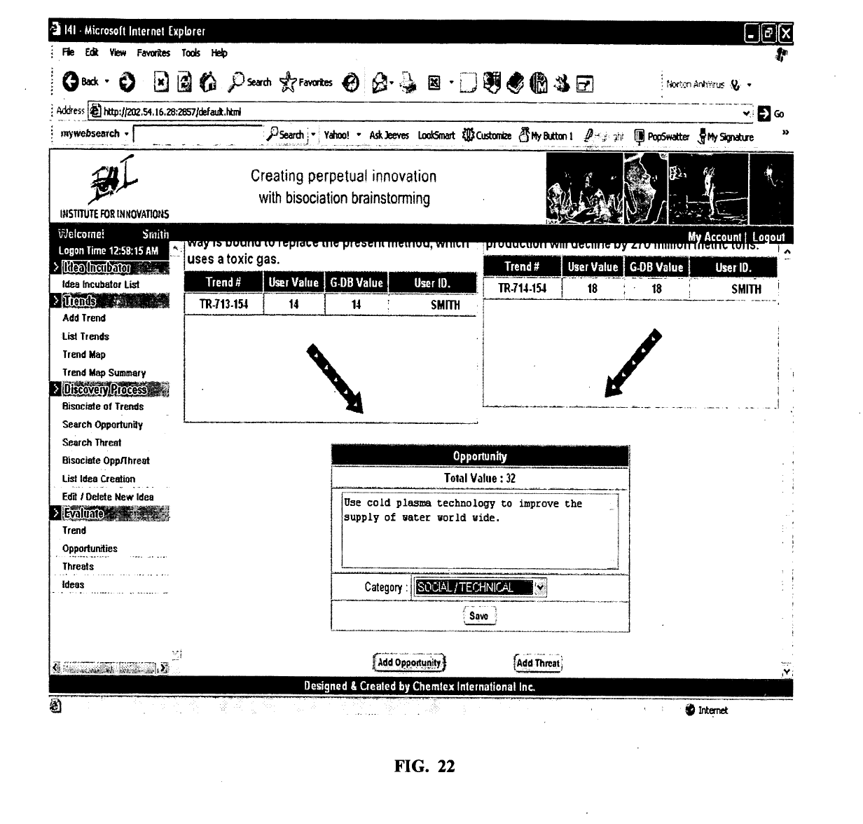

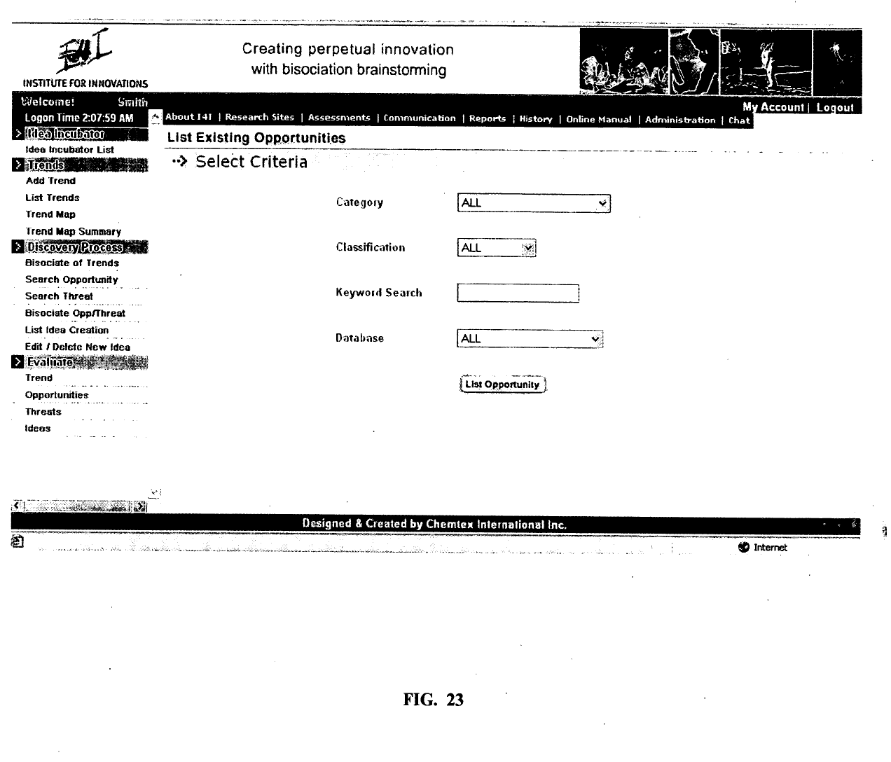

The next phase that is entered is referred to as the Discovery Process. Here is where the trends become bisociated. The first step in this process involves selection of a category from the Trend Categories as depicted by FIG. 19. This generates a list of trends for each category as shown in FIG. 20. From there a selection is made from both categories to effect the bisociation. This is shown in FIG. 21. These then lead the participant to develop possible opportunities as shown in FIG. 22. These are then listed as Existing Opportunities as pictured in FIG. 23.

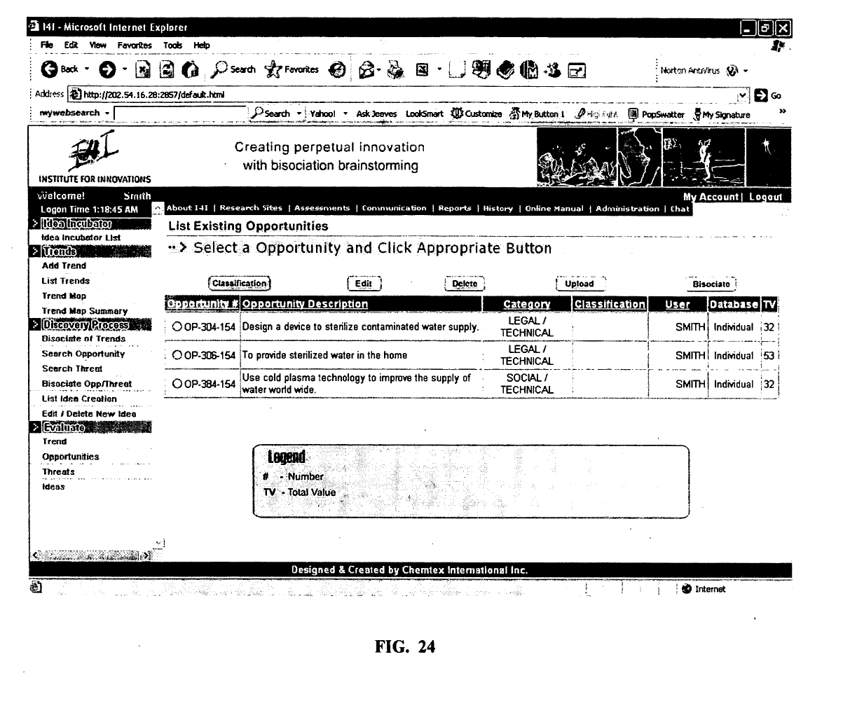

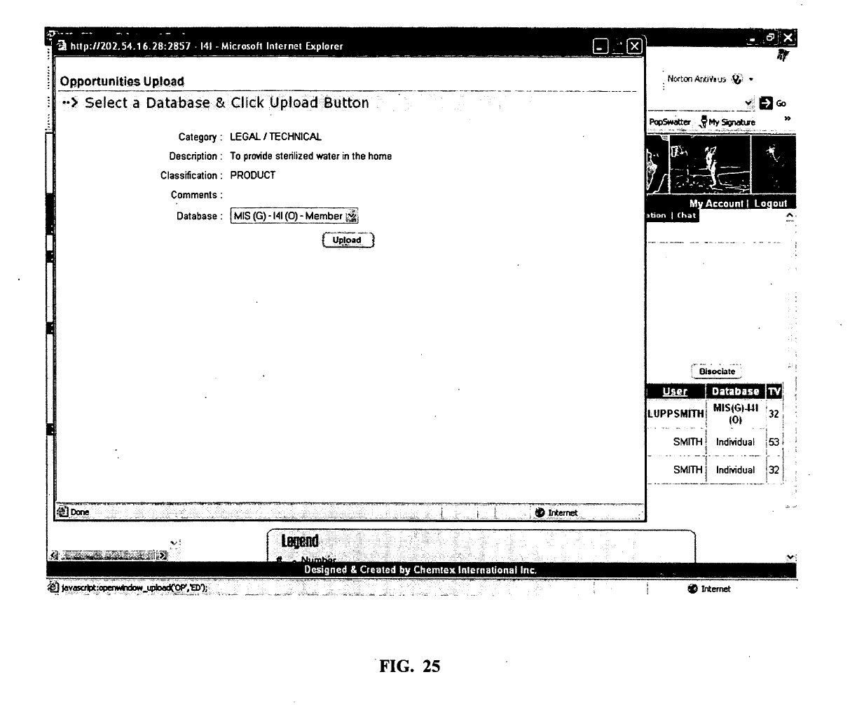

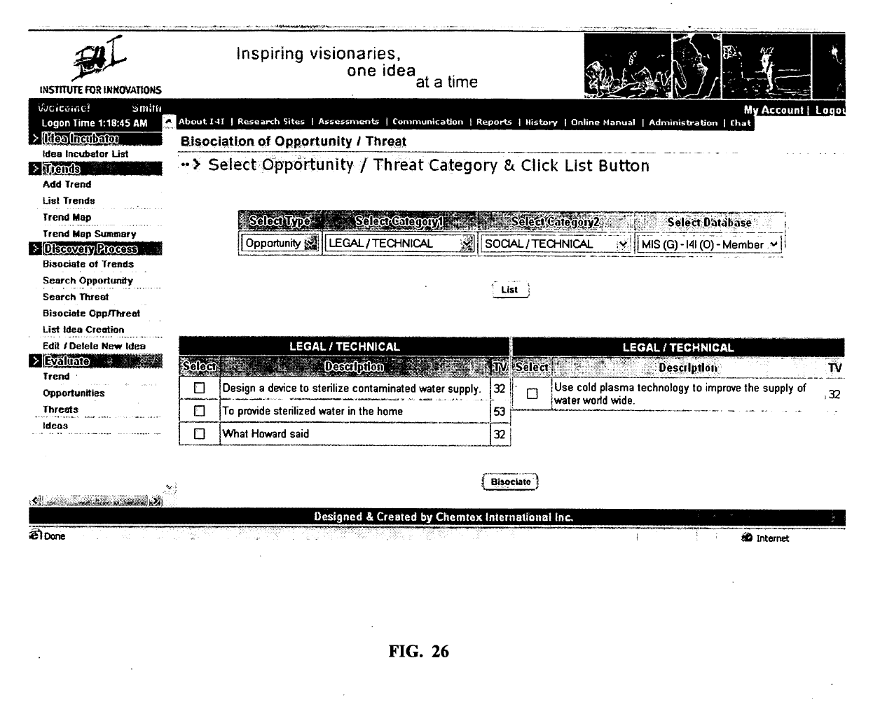

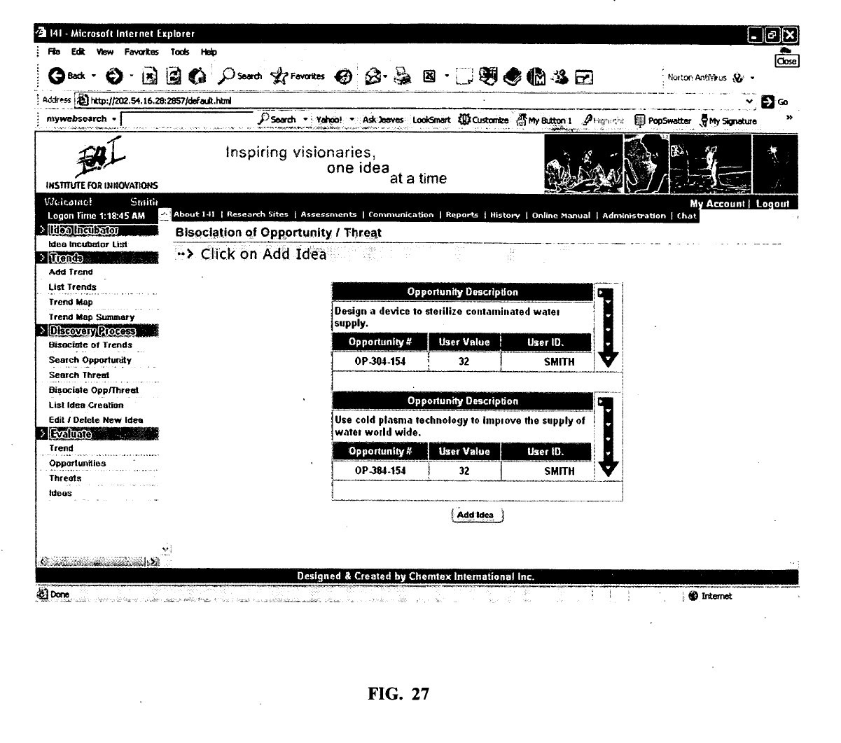

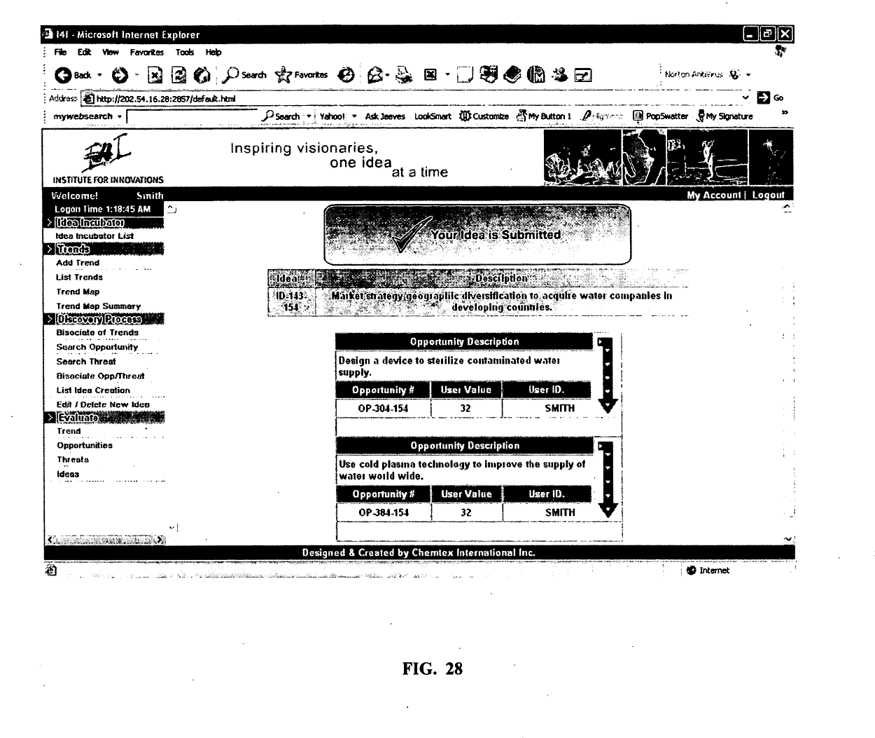

From there the Opportunity has to be classified and uploaded, as shown in FIG. 24. Then the opportunities are uploaded using another screen as shown by FIG. 25. Two categories are then presented which causes a bisociation. This in turn generates a new Idea as shown in FIG. 26. This idea is depicted in FIG. 27. It is in turn saved as shown in FIG. 28.

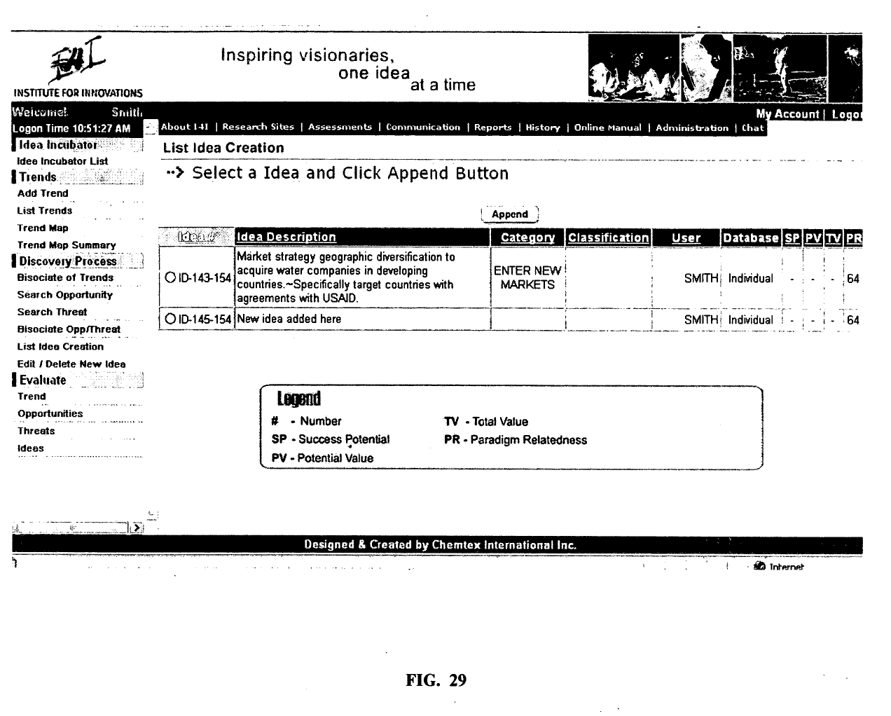

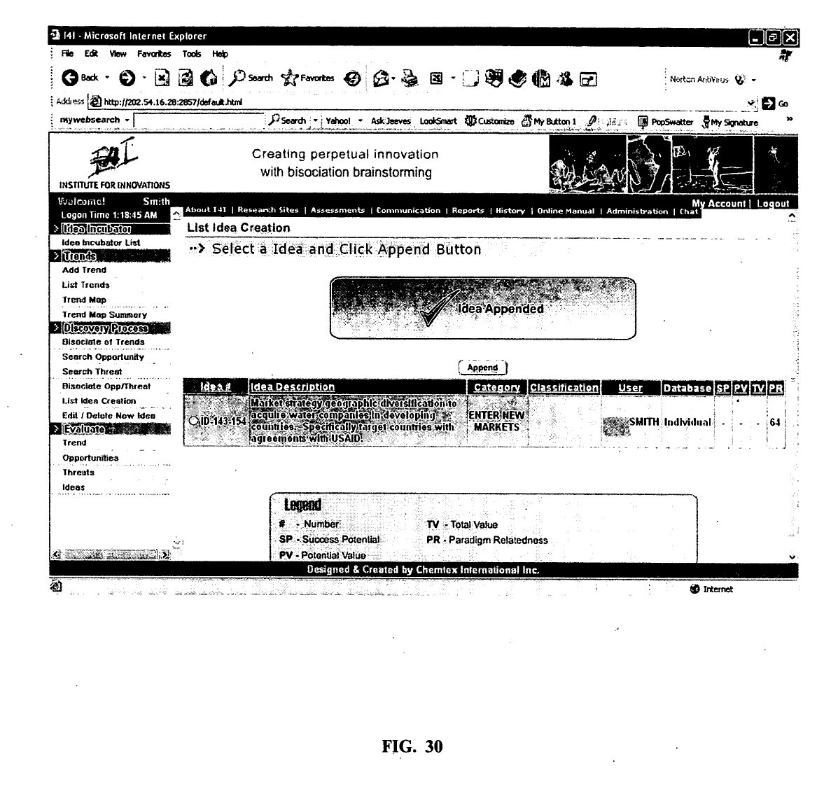

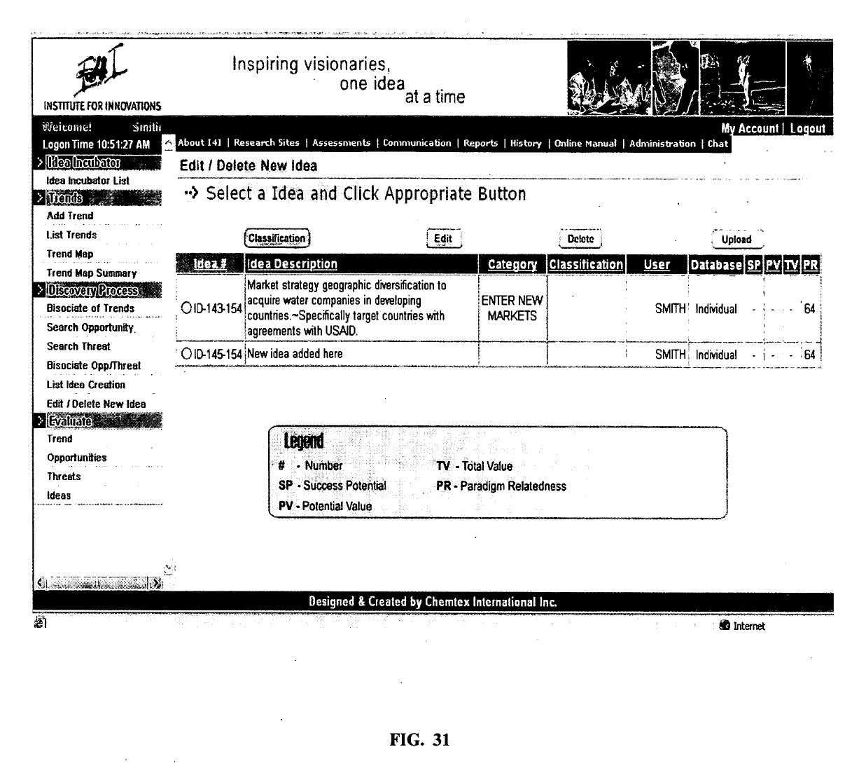

The ideas may also be appended. FIG. 29 shows the screen used to make changes to an existing idea. When the idea is actually appended a screen, FIG. 30, appears. Ideas can also be edited or deleted per FIG. 31.

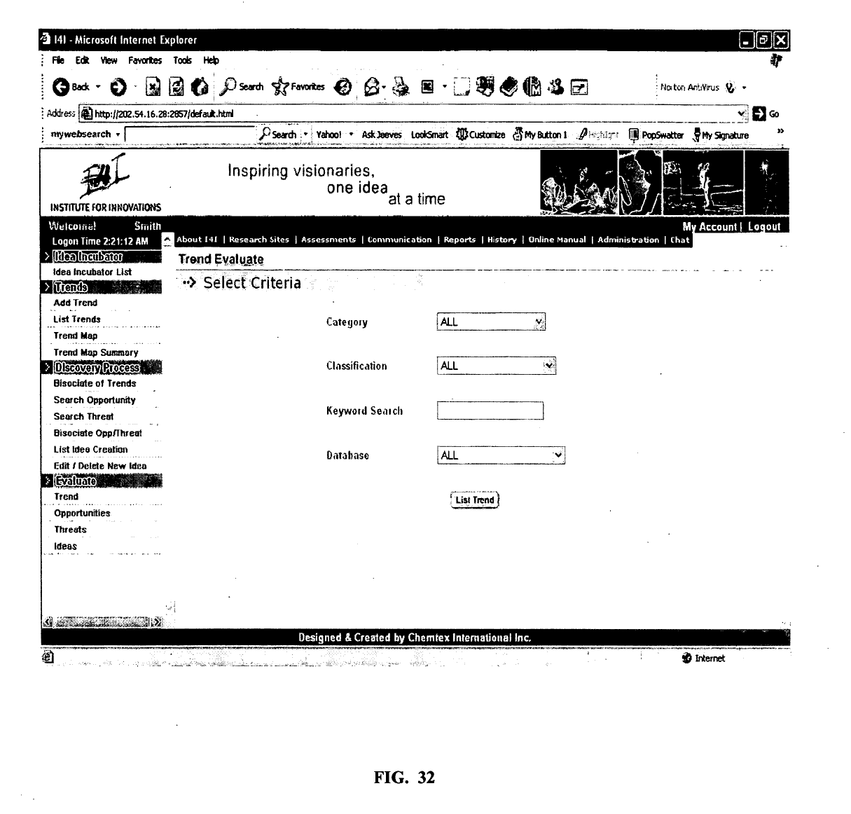

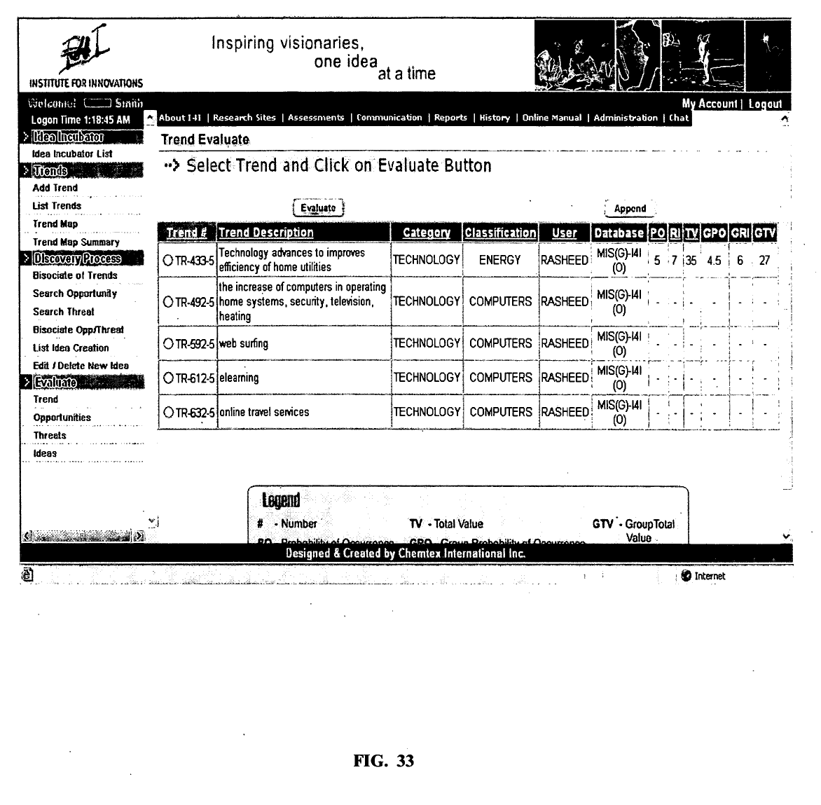

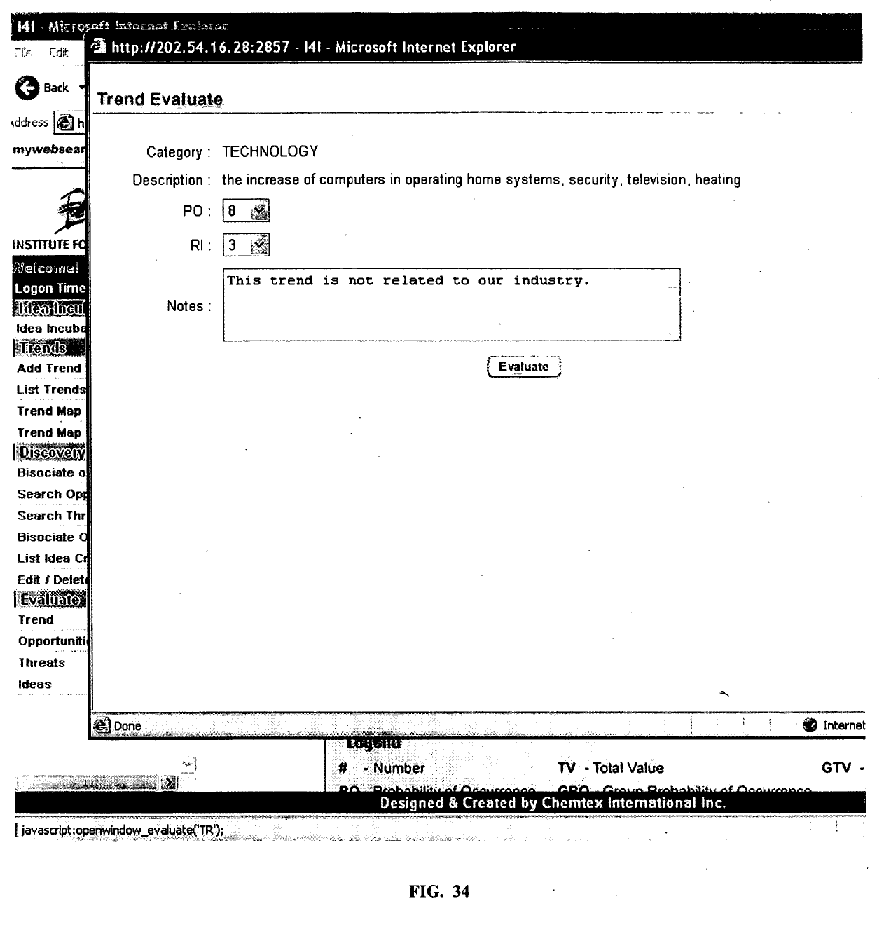

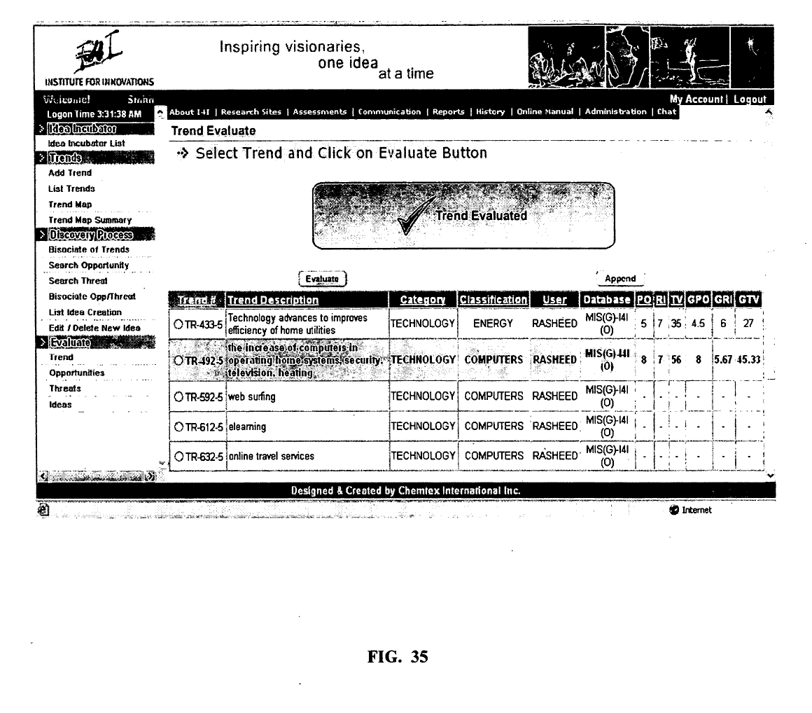

Trends are then further evaluated. By use of bisociation as a means of evaluating environmental variables at the societal, industrial and organizational levels, analyzing their interactive relationships to derive new and creative innovations and ideas. This process begins with the screen shown in FIG. 32. This process begins by clicking on the List Trends. Then a trend is selected and the evaluate option is used. The result is shown in FIG. 33. Following the appearance of this screen, trend is selected from the evaluate listing on the left part of the screen and the evaluate screen appears as shown in FIG. 34. After the evaluation is made, the Trend Evaluated screen then appears as pictured in FIG. 35.

Other selections for the participants include the evaluation of Opportunities, Threats and Ideas. If no ideas or threats are found in the system, screens are used to alert the conferees that this situation exists. The software as previously stated may be used for a single conference or may be part of an expanded program that uses it as a tool for compilation of ideas and data and also as a focusing agent.

Modification and variation can be made to the disclosed embodiment of the instant invention without departing from the scope of the invention as described. Those skilled in the art will appreciate that the applications of the present invention herein are varied, and that the invention is described in the preferred embodiment. Accordingly, additions and modifications can be made without departing from the principles of the invention. Particularly with respect to the claims it should be understood that changes may be made without departing from the essence of this invention. In this regard it is intended that such changes would still fall within the scope of the present invention. Therefore, this invention is not limited to the particular embodiments disclosed, but is intended to cover modifications within the spirit and scope of the present invention as defined in the appended claims.

What is claimed is:

1. A machine-readable data carrier comprising instructions configured to cause a data processor to operate a strategic visioning system by performing the following steps:
accepting one or more user-identified trends in each of two or more categories selected from the group consisting of economic, political/legal, social/cultural, technological, and unclassified;
associating each user-identified trend with its respective category;
successively displaying permutations of user-identified trends taken two at a time, each trend in a pair associated with a different category;
for each displayed pair of trends, optionally accepting one or more user-identified opportunities or threats, the generation of which may be prompted by the bisociation display of user-identified trends from different categories; and
associating each user-identified opportunity or threat with the two trend categories displayed when the user-identified opportunity or threat was accepted.

2. The machine-readable data carrier of claim 1, further comprising instructions configured to cause the data processor to perform the following steps:
successively displaying permutations of user-identified opportunities or threats taken two at a time, each opportunity or threat associated with a different pair of trend categories;
for each displayed pair of opportunities or threats, optionally accepting one or more user-identified strategic ideas, the generation of which may be prompted by the bisociation display of user-identified opportunities or threats from different pairs of trend categories; and
storing each user-identified strategic idea.

3. The machine-readable data carrier of claim 1 further comprising instructions configured to cause the data processor to perform the following steps:
accepting user-provided quality metrics with each user-identified trend; and
associating each user-identified trend with its user-provided quality metrics.

4. The machine-readable data carrier of claim 3 wherein the user-provided quality metrics comprise a Probability of Occurrence (PO) and a Relevance to Industry (RI).

5. The machine-readable data carrier of claim 4 further comprising instructions configured to cause the data processor to:
compute a Total Value (TV) score wherein TV=PO×RI; and
associate the TV score with each user-identified trend.

6. The machine-readable data carrier of claim 4 further comprising instructions configured to cause the data processor to display a 2-D graph of representations of user-identified trends plotted along axes of PO and RI.

7. The machine-readable data carrier of claim 6 further comprising instructions configured to cause the data processor to display a plurality of 2-D graphs of representations of user-identified trends plotted along axes of PO and RI, each graph displaying user-identified trends associated with a different category.

8. The machine-readable data carrier of claim 5 further comprising instructions configured to cause the data processor to perform the following steps:
accepting group-provided quality metrics for each user-identified trend; and
associating each user-identified trend with its group-provided quality metrics;
wherein the group-provided quality metrics comprise a Group Probability of Occurrence (GPO), a Group Relevance to Industry (GRI), and a Group Total Value (GTV).

9. The machine-readable data carrier of claim 1 wherein successively displaying permutations of user-identified trends taken two at a time comprises successively displaying permutations of those user-identified trends taken two at a time that match a user-selected filter.

10. The machine-readable data carrier of claim 2 further comprising instructions configured to cause the data processor to perform the following steps:
accepting user-provided quality metrics with each user-identified strategic idea; and
associating each user-identified strategic idea with its user-provided quality metrics.

11. The machine-readable data carrier of claim 10 wherein the user-provided quality metrics comprise a Success Potential (SP) and a Potential Value (PV).

12. A method of facilitating strategic idea generation, comprising:
accepting user-identified trends, each trend in one of a plurality of categories;
displaying permutations of user-identified trends taken two at a time, each trend in a pair associated with a different category;
for each displayed pair of trends, optionally accepting one or more user-identified opportunities or threats;
displaying permutations of user-identified opportunities or threats taken two at a time, each opportunity or threat in a pair associated with a different pair of trend categories;
for each displayed pair of opportunities or threats, optionally accepting one or more user-identified strategic ideas; and
storing each user-identified strategic idea.

13. The method of claim 12, further comprising accepting user-provided and group-provided quality metrics associated with one or more user-identified trends, opportunities or threats, or strategic ideas.

14. The method of claim 13, further comprising storing the user-identified trends, opportunities or threats, and strategic ideas, and any quality metrics associated therewith, in a database.
